(19) United States
(12) Patent Application Publication
(10) Pub. No.: US 2008/0198237 A1
(43) Pub. Date: Aug. 21, 2008

(54) SYSTEM AND METHOD FOR ADAPTIVE PIXEL SEGMENTATION FROM IMAGE SEQUENCES

(75) Inventors: Philip W. SMITH, Rockledge, FL (US); Richard Collier, Melbourne, FL (US)

Correspondence Address: ALLEN, DYER, DOPPELT, MILBRATH & GILCHRIST, 255 S ORANGE AVENUE, SUITE 1401, ORLANDO, FL, 32801, US

(73) Assignee: Harris Corporation, Melbourne, FL (US)

(21) Appl. No.: 11/675,793

(22) Filed: Feb. 16, 2007

(51) Int. Cl. G06K 9/36; H04N 5/228

(52) U.S. Cl. 348/222.1; 382/236; 348/E05.024

(57) ABSTRACT

The image processing system includes an image processor performing adaptive pixel segmentation for a sequence of image frames collected during movement relative to a scene, with each image frame having a plurality of pixels. An image sensor collects the sequence of image frames while moving relative to the scene. The image processor may perform the adaptive pixel segmentation by generating a probability density function (PDF) for pixels based upon a plurality of past image frames from the sequence thereof, determining whether pixels in a new image frame from the sequence thereof are independently moving pixels or background pixels based upon comparing the new image frame to the at least one PDF, and updating the at least one PDF based upon the new image frame.

### FIELD OF THE INVENTION

The present invention relates to the field of surveillance, and, more particularly, to systems and methods for foreground/background pixel segmentation from collected images.

### BACKGROUND OF THE INVENTION

Many modern video-based tracking systems for airborne surveillance use direct deterministic models with predictive constraints to capture the apparent background motion caused by a moving camera. When used in culturally sparse environments, such approaches usually assume that a majority of the scene falls on a dominant plane and thus inter-frame homographies can be computed using robust linear least squares techniques. The set of successive frame-to-frame homographies can then be used to create a sequence mosaic, or still overview of the scene, which allows for simple background subtraction in a common reference frame. Because these deterministic techniques do not accurately model parallax or dynamic backgrounds, such as swaying trees or rolling water, many background objects may be mistaken for potential moving targets. While deterministic techniques are available which model parallax, they typically require specialized hardware to be computationally feasible and still may not handle dynamic backgrounds.

U.S. Pat. No. 6,876,999 to Hill, et al. entitled “Methods and apparatus for extraction and tracking of objects from multi-dimensional sequence data” is an object tracking technique which, given: (i) a potentially large data set; (ii) a set of dimensions along which the data has been ordered; and (iii) a set of functions for measuring the similarity between data elements, a set of objects are produced. Each of these objects is defined by a list of data elements. Each of the data elements on this list contains the probability that the data element is part of the object. The method produces these lists via an adaptive, knowledge-based search function which directs the search for high-probability data elements. This serves to reduce the number of data element combinations evaluated while preserving the most flexibility in defining the associations of data elements which comprise an object.

United States Patent Application Publication 2004/0239762 A1 to Porikli et al. entitled “Adaptive Background Image Updating” is directed to a method that compares a background image to input images to determine a similarity score for each input image. Then, the background image is updated only if the similarity score for a particular image is less than a predetermined threshold. Presumably, any pixel whose color does not change is part of a static background, and any pixel that does change is part of a moving object. The similarity score controls when input images are scored and the manner the background image is updated.

United States Patent Application Publication 2002/0168091 A1 to Trajkovic entitled “Motion Detection Via Image Alignment” discloses a method and system where pixels of an image are classified as being stationary or moving, based on the gradient of the image in the vicinity of each pixel. The values of corresponding pixels in two sequential images are compared. If the difference between the values is less than the image gradient about the pixel location, or less than a given threshold value above the image gradient, the pixel is classified as being stationary. By classifying each pixel based on the image gradient in the vicinity of the pixel, the sensitivity of the motion detection classification is reduced at the edges of objects, and other regions of contrast in an image, thereby minimizing the occurrences of ghost artifacts caused by the misclassification of stationary pixels as moving pixels.

The paper by A. Mittal and N. Paragios published in the Proceedings of the 2005 IEEE Conference on Computer Vision and Pattern Recognition entitled “Motion-Based Background Subtraction using Adaptive Kernel Density Estimation” describes a statistical technique for classifying pixels as movers or background in the presence of dynamic backgrounds and a stationary camera. Images acquired before moving targets enter the camera's field-of-view are used to estimate probability distribution functions (PDF) for the expected colors of each pixel in the scene, enabling the method to correctly label naturally occurring motions such as rolling waves and swaying trees as part of the background. Once targets enter the scene, pixels that fall outside of their expected PDF are labeled as belonging to moving objects.

Increasing demands for pervasive, persistent, and purposeful (P3) surveillance require background modeling methods that capture parallax-induced motion because many state-of-the-art approaches model only a dominant ground plane. In such systems, parallax motions are identified as movers which must be filtered using heuristics or secondary algorithms. Modeling dynamic backgrounds is required because most application environments contain dynamic elements that should be modeled as background activity, such as swaying trees or water.

The surveillance may desirably require no user intervention as the methods for P3 surveillance should help analysts manage and interpret the deluge of data they receive, not require constant interaction. Also, custom hardware should not be required because for truly pervasive surveillance, any motion detection system should be affordable, limiting the practicality of expensive specialized hardware.

### SUMMARY OF THE INVENTION

In view of the foregoing background, it is therefore an object of the present invention to provide a system and method for adaptive pixel segmentation for a sequence of image frames collected during movement relative to a scene with decreased user intervention and modeling of dynamic backgrounds and parallax-induced motion.

This and other objects, features, and advantages in accordance with the present invention are provided by an image processing system including an image processor performing adaptive pixel segmentation for a sequence of image frames collected during movement relative to a scene, with each image frame comprising a plurality of pixels. The image processor may perform the adaptive pixel segmentation by generating at least one probability density function (PDF) for pixels based upon a plurality of past image frames from the sequence thereof, determining whether pixels in a new image frame from the sequence thereof are independently moving pixels or background pixels based upon comparing the new image frame to the at least one PDF, and updating the at least one PDF based upon the new image frame. The system decreases user intervention and models dynamic backgrounds and parallax-induced motion.

An image sensor preferably collects the sequence of image frames while moving relative to the scene. The image processor may generate the PDF by generating a space-time volume mosaic in a common reference frame based upon inter-frame homographies of the sequence of image frames, which may include providing a feature history for each pixel, including a history of the pixel's residual motion and color in the common reference frame.

The PDF may be generated via variable bandwidth Parzen windowing, based upon the history of each pixel's residual motion and color in the common reference frame, to provide a five-dimensional, probabilistic representation of each pixel in the common reference frame over time. Also, generating the PDF may include generating per-pixel probabilistic background models which incorporate both parallax and background motion effects based upon an initial training sequence in which no independently moving pixels are present. The image processor may detect independently moving pixels using a pixel dependent adaptive thresholding scheme in view of the per-pixel probabilistic background models. Furthermore, the image processor may update the per-pixel probabilistic background models when pixels in the new image frame are determined to be background pixels.

A method aspect is directed to adaptive pixel segmentation for a sequence of image frames generated by an image sensor moving relative to a scene. The method may include generating at least one probability density function (PDF) for pixels based upon a plurality of past image frames from the sequence, determining whether pixels in a new image frame from the sequence are independently moving pixels or background pixels based upon comparing the new image frame to the at least one PDF, and updating the at least one PDF based upon the new image frame.

Generating the PDF may include generating a space-time volume mosaic in a common reference frame based upon inter-frame homographies of the sequence of image frames includes providing a feature history for each pixel, which may also include providing a history of the pixel's residual motion and color in the common reference frame. The PDF may be generated via variable bandwidth Parzen windowing, based upon the history of each pixel's residual motion and color in the common reference frame, to provide a five-dimensional, probabilistic representation of each pixel in the common reference frame over time. Furthermore, generating the PDF may include generating per-pixel probabilistic background models which include both parallax and background motion effects based upon an initial training sequence in which no independently moving pixels are present. Moreover, determining may include detecting independently moving pixels using a pixel dependent adaptive thresholding scheme in view of the per-pixel probabilistic background models, and updating may include updating the per-pixel probabilistic background models when pixels in the new image frame are determined to be background pixels.

### BRIEF DESCRIPTION OF THE DRAWINGS

FIG. 1 is a schematic block diagram illustrating an image processing system in accordance with the present invention.

FIG. 2 is a schematic diagram illustrating further details of the image processing system of FIG. 1.

FIG. 3 is a flowchart for the method corresponding to the image processing system as shown in FIG. 2.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As an alternative to the direct, deterministic approaches discussed in the background above, the invention provides an approach to this problem from a probabilistic perspective. Instead of using the inter-frame homographies to construct a still-frame mosaic, the present approach uses the inter-frame homographies to construct a mosaic volume in a common reference frame. Because this “mosaic movie” provides a history of each pixel's residual motion and color in a common viewing frame over time, a non-parametric density function can be computed via adaptive bandwidth Parzen windowing to provide a five-dimensional, probabilistic representation of each pixel in the frame.

Although pixels with non-planar motions caused by parallax or background motions may not project to correct locations in this reference frame, these behaviors can easily be captured by the probabilistic per-pixel background model. Given an initial training sequence in which no targets of interest are present, the system of the present invention will construct per-pixel probabilistic background models which incorporate both parallax and background motion effects.

After the per-pixel background models are recovered, independently moving pixels can be detected using a pixel dependent adaptive thresholding scheme. If a pixel's features in the current frame fall outside of specified boundaries of it's background kernel estimate, it is labeled as an independent mover. If they fall inside the boundaries, then the background model is updated using these new measurements. The boundary thresholds may be automatically tuned during operations to allow for trade-offs between the probability of missing a target and the probability of false detection from the available kernel estimates.

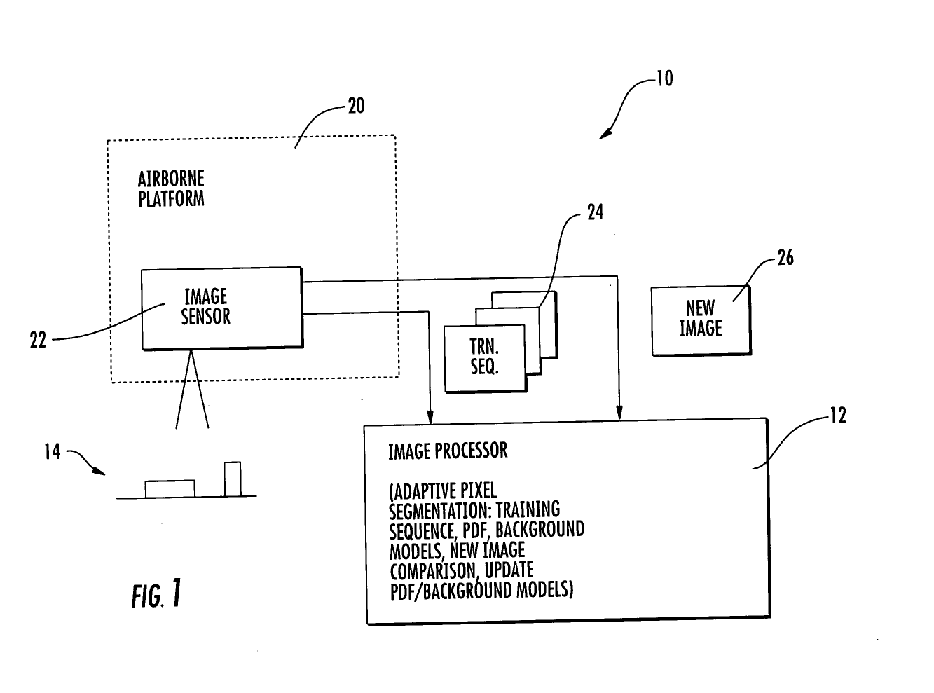

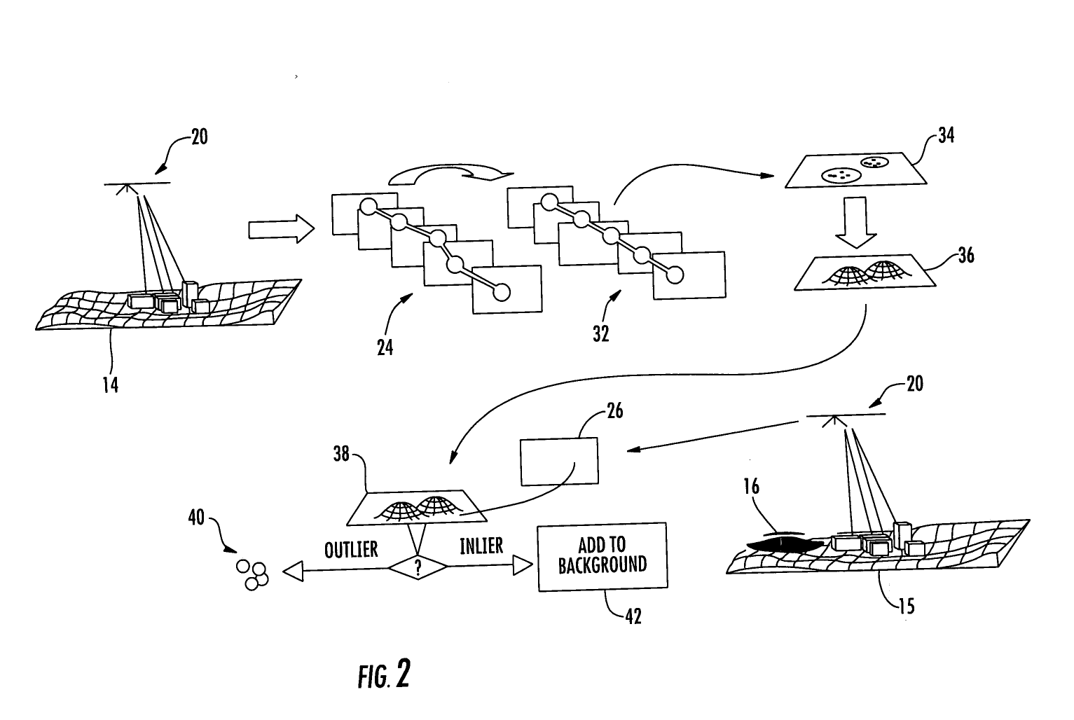

Referring initially to FIGS. 1 and 2, an image processing system 10 for adaptive pixel segmentation for a sequence of image frames collected during movement relative to a scene 14/15 will be described. An image sensor 22 preferably collects the sequence of image frames while moving relative to the scene 14/15. The image sensor 22 may be carried by an airborne platform 20 such as a surveillance asset, e.g. an airplane or satellite.

The image processing system 10 decreases user intervention and models dynamic backgrounds and parallax-induced motion. The image processing system 10 includes an image processor 12 to perform the adaptive pixel segmentation for the sequence of image frames collected during movement relative to the scene 14/15. Each image frame includes a plurality of pixels as would be appreciated by those skilled in the art. Furthermore, as used throughout this description, the term “video” refers to images, particularly a series of framed images, that may be transmitted by number of frames per second and/or the amount of time between switching frames.

The image processor 12 may perform the adaptive pixel segmentation by generating at least one probability density function (PDF) 36 for pixels based upon a plurality of training sequence images 24 or past image frames from the sequence thereof. The image processor 12 determines whether pixels in a new image frame 26, e.g. from the sequence and/or imaging the scene 15 with a moving target 16, are independently moving pixels 40 or background pixels 42 based upon comparing the new image frame 26 to the at least one PDF 36, and updating the at least one PDF based upon the new image frame.

The image processor 12 may generate the PDF 36 by generating a space-time mosaic volume 32 in a common reference frame based upon inter-frame homographies 24/32 of the sequence of image frames 24, which may include providing a feature history 34 for each pixel, including a history of the pixel's residual motion and color in the common reference frame. Homographies are projective transformations that map points from one image frame to another image frame, as would be appreciated by those skilled in the art.

The PDF 36 may be generated via variable bandwidth Parzen windowing, based upon the history of each pixel's residual motion and color in the common reference frame, to provide a five-dimensional, probabilistic representation of each pixel in the common reference frame over time. Also, generating the PDF 36 may include generating per-pixel probabilistic background models which incorporate both parallax and background motion effects based upon the initial training sequence 24 in which no independently moving pixels are present.

The image processor 12 may detect independently moving pixels 40 using a pixel dependent adaptive thresholding scheme 38 in view of the per-pixel probabilistic background models. Furthermore, the image processor 12 may update the per-pixel probabilistic background models when pixels in the new image frame 26 are determined to be background pixels 42.

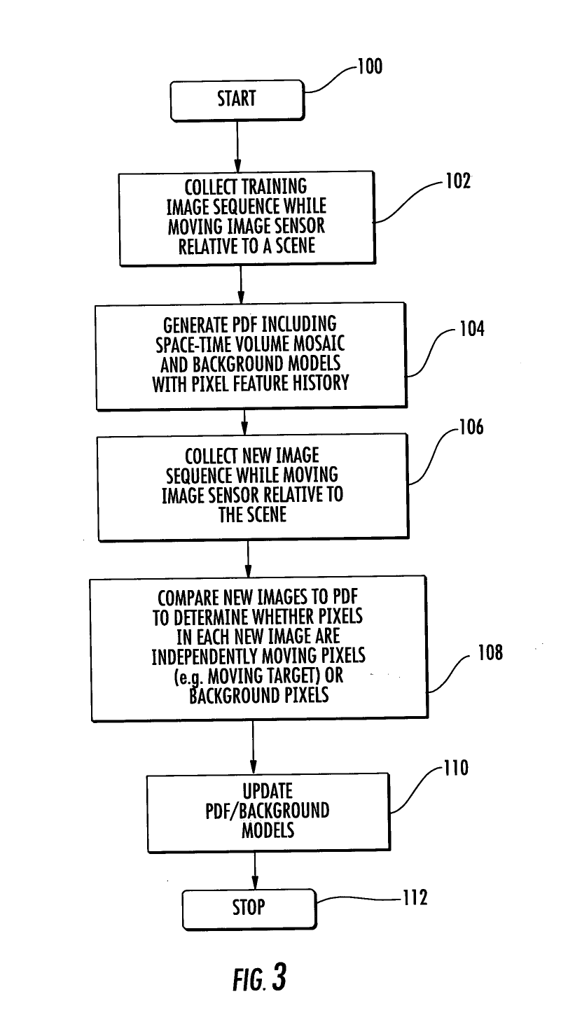

A method aspect will be described with further reference to FIG. 3. The method is directed to adaptive pixel segmentation for a sequence of image frames and begins at block 100. An image sensor 22 is moved relative to a scene 14/15 and a training image sequence 24 is collected (block 102). The method includes (block 104) generating at least one probability density function (PDF) 36 for pixels based upon a plurality of past image frames 24 from the sequence.

Generating the PDF 36 may include generating a space-time mosaic volume 32 in a common reference frame based upon inter-frame homographies of the sequence of image frames includes providing a feature history 34 for each pixel, which may also include providing a history of the pixel's residual motion and color in the common reference frame. The PDF 36 may be generated via variable bandwidth Parzen windowing, based upon the history 34 of each pixel's residual motion and color in the common reference frame, to provide a five-dimensional, probabilistic representation of each pixel in the common reference frame over time. Furthermore, generating the PDF 36 may include generating per-pixel probabilistic background models which include both parallax and background motion effects based upon an initial training sequence 24 in which no independently moving pixels are present.

At block 108, the method includes determining whether pixels in a new image frame 26, collected at block 106, are independently moving pixels 40 or background pixels 42 based upon comparing the new image frame 26 to the PDF. Then, the PDF/background models are updated (block 110) based upon the new image frame 26 before ending at block 112. Such determining may include detecting independently moving pixels 40 using a pixel dependent adaptive thresholding scheme 38 in view of the per-pixel probabilistic background models, and updating may include updating the per-pixel probabilistic background models when pixels in the new image frame 26 are determined to be background pixels 42.

The image processing system and method models dynamic backgrounds and parallax-induced motion. The approach replaces deterministic apparent motion models with a robust, adaptive, probalistic model that can handle dynamic backgrounds such as swaying trees, moving or rolling water etc. Also, the approach properly detects parallax-induced motion without feature matching which is often unreliable.

The system and method can be used for multi-ground-target tracking capability, activity monitoring and interpretation, and video-based Automatic Target Recognition/Automatic Target Correlation (ATR/ATC). For example, once the independently moving pixels are located in a given frame, their feature data and coordinates may be passed to a tracker to determine whether or not they represent new or existing targets. The tracking system may first group pixels based on spatial proximity and residual motion similarity in the common planar frame using simple distance thresholds. Any independently moving pixels not belonging to a large enough grouping are preferably rejected. The tracker may then decide whether or not each group belongs to an existing object or should represent a new target. Groups may be used as updates if they 1) are temporally consistent with an existing track and 2) have a similar color appearance, otherwise a new target track will be added. A predictive model, such as a Kalman filter, may be used to enforce the temporal constraint.

Furthermore, once tracks are determined through the mosaic volume, a scale and rotation invariant space-time correlation scheme may be used to provide a preliminary interpretation of the tracked objects behavior. Space-time correlation is a state-of-the-art technique in which a short volume template of an action sequence, such as running into a restricted area, crawling on a border, or trucks entering a compound, can be swept across a video volume in much the same way a two-dimensional template can be used in traditional imagery. Target volumes with significant similarity to a given behavior template can be labeled as performing that action. The strength of such an approach is that it does not require explicit optical flow computation, but it is computationally expensive to apply to entire space-time volumes.

Because the present approach has already identified the potential movers, however, the matching process can be orders of magnitude faster because the correlation process may be restricted to the target's path. When the system is able to link a possible behavior to a given target, the system will pass that information along to the analyst along with the target's track data.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. An image processing system comprising:
an image processor performing adaptive pixel segmentation for a sequence of image frames collected during movement relative to a scene, with each image frame comprising a plurality of pixels;
the image processor performing the adaptive pixel segmentation by
generating at least one probability density function (PDF) for pixels based upon a plurality of past image frames from the sequence thereof,
determining whether pixels in a new image frame from the sequence thereof are independently moving pixels or background pixels based upon comparing the new image frame to the at least one PDF, and
updating the at least one PDF based upon the new image frame.

2. The image processing system according to claim 1 further comprising an image sensor for collecting the sequence of image frames while the image sensor moves relative to the scene.

3. The image processing system according to claim 1 wherein generating the at least one PDF includes generating a space-time volume mosaic in a common reference frame based upon inter-frame homographies of the sequence of image frames.

4. The image processing system according to claim 3 wherein generating the space-time volume mosaic includes providing a feature history for each pixel.

5. The image processing system according to claim 4 wherein the feature history for each pixel includes a history of the pixel's residual motion and color in the common reference frame.

6. The image processing system according to claim 5 wherein the at least one PDF is generated via variable bandwidth Parzen windowing, based upon the history of each pixel's residual motion and color in the common reference frame, to provide a five-dimensional, probabilistic representation of each pixel in the common reference frame over time.

7. The image processing system according to claim 1 wherein generating the at least one PDF includes generating per-pixel probabilistic background models which incorporate both parallax and background motion effects based upon an initial training sequence in which no independently moving pixels are present.

8. The image processing system according to claim 7 wherein the image processor detects independently moving pixels using a pixel dependent adaptive thresholding scheme in view of the per-pixel probabilistic background models.

9. The image processing system according to claim 8 wherein the image processor updates the per-pixel probabilistic background models when pixels in the new image frame are determined to be background pixels.

10. An image processing system comprising:
an image sensor for collecting a sequence of image frames while the image sensor moves relative to a scene;
an image processor performing adaptive pixel segmentation for the sequence of image frames collected during movement relative to the scene, with each image frame comprising a plurality of pixels;
the image processor performing the adaptive pixel segmentation by
generating at least one probability density function (PDF) for pixels based upon a plurality of past image frames from the sequence thereof, including generating a space-time volume mosaic in a common reference frame based upon inter-frame homographies of the sequence of image frames,
determining whether pixels in a new image frame from the sequence thereof are independently moving pixels or background pixels based upon comparing the new image frame to the at least one PDF, and
updating the at least one PDF based upon the new image frame.

11. The image processing system according to claim 10 wherein generating the space-time volume mosaic includes providing a feature history for each pixel.

12. The image processing system according to claim 11 wherein the feature history for each pixel includes a history of the pixel's residual motion and color in the common reference frame.

13. The image processing system according to claim 12 wherein the at least one PDF is generated via variable bandwidth Parzen windowing, based upon the history of each pixel's residual motion and color in the common reference frame, to provide a five-dimensional, probabilistic representation of each pixel in the common reference frame over time.

14. An image processing system comprising:
an image sensor for collecting a sequence of image frames while the image sensor moves relative to a scene;
an image processor performing adaptive pixel segmentation for the sequence of image frames collected during movement relative to the scene, with each image frame comprising a plurality of pixels;
the image processor performing the adaptive pixel segmentation by
generating at least one probability density function (PDF) for pixels based upon a plurality of past image frames from the sequence thereof, including generating per-pixel probabilistic background models which incorporate both parallax and background motion effects based upon an initial training sequence in which no independently moving pixels are present,
determining whether pixels in a new image frame from the sequence thereof are independently moving pixels or background pixels based upon comparing the new image frame to the at least one PDF, and
updating the at least one PDF based upon pixels of the new image frame.

15. The image processing system according to claim 14 wherein the image processor detects independently moving pixels using a pixel dependent adaptive thresholding scheme in view of the per-pixel probabilistic background models.

16. The image processing system according to claim 15 wherein the image processor updates the per-pixel probabilistic background models when pixels in the new image frame are determined to be background pixels.

17. An adaptive pixel segmentation method for a sequence of image frames generated by an image sensor moving relative to a scene, the method comprising:
generating at least one probability density function (PDF) for pixels based upon a plurality of past image frames from the sequence;
determining whether pixels in a new image frame from the sequence are independently moving pixels or background pixels based upon comparing the new image frame to the at least one PDF; and
updating the at least one PDF based upon the new image frame.

18. The adaptive pixel segmentation method according to claim 17 wherein generating the at least one PDF includes generating a space-time volume mosaic in a common reference frame based upon inter-frame homographies of the sequence of image frames.

19. The adaptive pixel segmentation method according to claim 18 wherein generating the space-time volume mosaic includes providing a feature history for each pixel.

20. The adaptive pixel segmentation method according to claim 19 wherein the feature history for each pixel includes a history of the pixel's residual motion and color in the common reference frame.

21. The adaptive pixel segmentation method according to claim 20 wherein the PDF is generated via variable bandwidth Parzen windowing, based upon the history of each pixel's residual motion and color in the common reference frame, to provide a five-dimensional, probabilistic representation of each pixel in the common reference frame over time.

22. The adaptive pixel segmentation method according to claim 17 wherein generating the PDF includes generating per-pixel probabilistic background models which include both parallax and background motion effects based upon an initial training sequence in which no independently moving pixels are present.

23. The adaptive pixel segmentation method according to claim 22 wherein determining includes detecting independently moving pixels using a pixel dependent adaptive thresholding scheme in view of the per-pixel probabilistic background models.

24. The adaptive pixel segmentation method according to claim 23 wherein updating includes updating the per-pixel probabilistic background models when pixels in the new image frame are determined to be background pixels.
